(19) United States
(12) Patent Application Publication
(10) Pub. No.: US 2006/0039298 A1
(43) Pub. Date: Feb. 23, 2006

(54) Logical and physical mesh network separation

(75) Inventors: Juan Carlos Zuniga, Montreal (CA); Marian Rudolf, Montreal (CA); Shamim Akbar Rahman, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/169,492

(22) Filed: Jun. 29, 2005

Related U.S. Application Data
(60) Provisional application No. 60/586,504, filed on Jul. 9, 2004.

(51) Int. Cl. H04J 1/16

(52) U.S. Cl. 370/252; 370/401

(57) ABSTRACT

A method for creating sub-networks in a wireless mesh network begins by determining whether a trigger condition for creating a sub-network exists. Nodes in the mesh network are selected to create the sub-network if the trigger condition exists. The sub-network is then created with the selected nodes. A node for use in a wireless mesh network includes a state device for maintaining a state of the node, the state of the node relating to activity occurring at the node; an attachment list communicating with the state device; a trigger device communicating with the state device; and an attachment device communicating with the attachment list and the trigger device.

### CROSS REFERENCE TO RELATED APPLICATION(S)

This application claims the benefit of U.S. Provisional Application No. 60/586,504, filed Jul. 9, 2004, which is incorporated by reference as if fully set forth herein.

### FIELD OF INVENTION

The present invention generally relates to wireless mesh networks, and more particularly, to a method for separating a mesh network into smaller logical and/or physical mesh sub-networks.

### BACKGROUND

Due to the increasing usage and widespread deployment of Wireless Local Area Networks (WLANs), additional support for wireless mesh networks has recently gained momentum in the standards community. A mesh network is a third and complementary method for connecting wireless nodes, supplementing the Infrastructure and Ad-Hoc modes. The driving forces and possible fields of application with mesh networks include low-effort coverage extension for WLANs, low-effort and low-complexity self-deploying networks, and highly reliable and fault-tolerant networks.

In Infrastructure mode, a station (STA) exclusively communicates with a base station or an access point (AP). In the Ad-Hoc mode (Peer-to-Peer), the STAs can communicate directly without involving any other node in the network. Mesh networks provide a mixture of Infrastructure and Ad-Hoc modes. For example, nodes in the network (STAs, APs, etc.) can act as wireless routers for other nodes not in range of a base station.

Many system operational aspects (such as operations and maintenance (O&M), backbone connectivity, connectivity to nodes over time, radio resource management (RRM), user behavior, etc.) differ significantly when comparing wireless mesh networks to traditional wireless networks operating mostly in Infrastructure mode or Ad-Hoc mode. For example, instead of deploying a single 100-node mesh network, distributed software could be present in each of the nodes that would self-organize the system into two or more separate mesh sub-networks. These mesh sub-networks could be overlapping or could have no overlap, but would still be neighboring. There is a need to enable efficient operation and use of mesh networks through simple logical network separation.

### SUMMARY

The present invention includes several methods for enabling efficient operation and use of mesh networks through a simple logical network separation. The present invention includes methods to spawn one or more mesh sub-networks instead of one large network. The sub-networks can be either logical or physical.

Given a set of nodes, the invention allows a higher degree of organization and more flexibility for operating the mesh network by introducing the notion of physical and logical sub-networks. In addition, several additional features are disclosed, such as functional entities and signaling, to enable this mode of operation.

A method for creating sub-networks in a wireless mesh network begins by determining whether a trigger condition for creating a sub-network exists. Nodes in the mesh network are selected to create the sub-network if the trigger condition exists. The sub-network is then created with the selected nodes.

A node for use in a wireless mesh network includes a state device; an attachment list communicating with the state device for maintaining a state of the node, the state of the node relating to activity occurring at the node; a trigger device communicating with the state device; and an attachment device communicating with the attachment list and the trigger device.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a diagram of a complete physical mesh network;

FIG. 2 is a diagram of a primary logical mesh network;

FIG. 3 is a diagram of a secondary logical mesh network;

FIG. 4 is a state diagram of the three states of a node in the network;

FIG. 5 is a flowchart of a method for separating a mesh network into multiple sub-networks; and

FIG. 6 is a block diagram of a node configured to implement the method shown in FIG. 5.

### DETAILED DESCRIPTION OF THE PREFERRED EMBODIMENTS

Hereafter, the term “station” (STA) includes, but is not limited to, a wireless transmit/receive unit (WTRU), a user equipment, a fixed or mobile subscriber unit, a pager, or any other type of device capable of operating in a wireless environment. When referred to hereafter, the term “access point” (AP) includes, but is not limited to, a base station; a STA with extra functionality that allows it to behave as central point in a star topology, similar to a base station; a Node B; a site controller; or any other type of interfacing device in a wireless environment. Likewise, when referred to hereafter, the term “mesh point” (MP) or “mesh node” includes, but it is not limited to, a STA with extra functionalities that allows it to behave as a forwarding node in a mesh topology and is capable of generating, sending, receiving, and or relaying traffic from other nodes in the network. Since these terms refer to logical functionalities, it is possible to have only one logical functionality per physical device or to combine two or more logical functionalities into a physical device. Hence, when referred to hereafter, the term “mesh access point” (MAP) includes, but it is not limited to, a STA with AP and MP functionalities.

The present invention includes several methods for enabling efficient operation and use of mesh networks through a simple logical network separation. Currently, when deploying a mesh network in a specific area, the common approach is to form a single (and possibly very large) network. In certain scenarios, there are benefits to consider in spawning one or more mesh sub-networks instead of working with one large network. The sub-network can be defined either from a logical or a physical point of view.

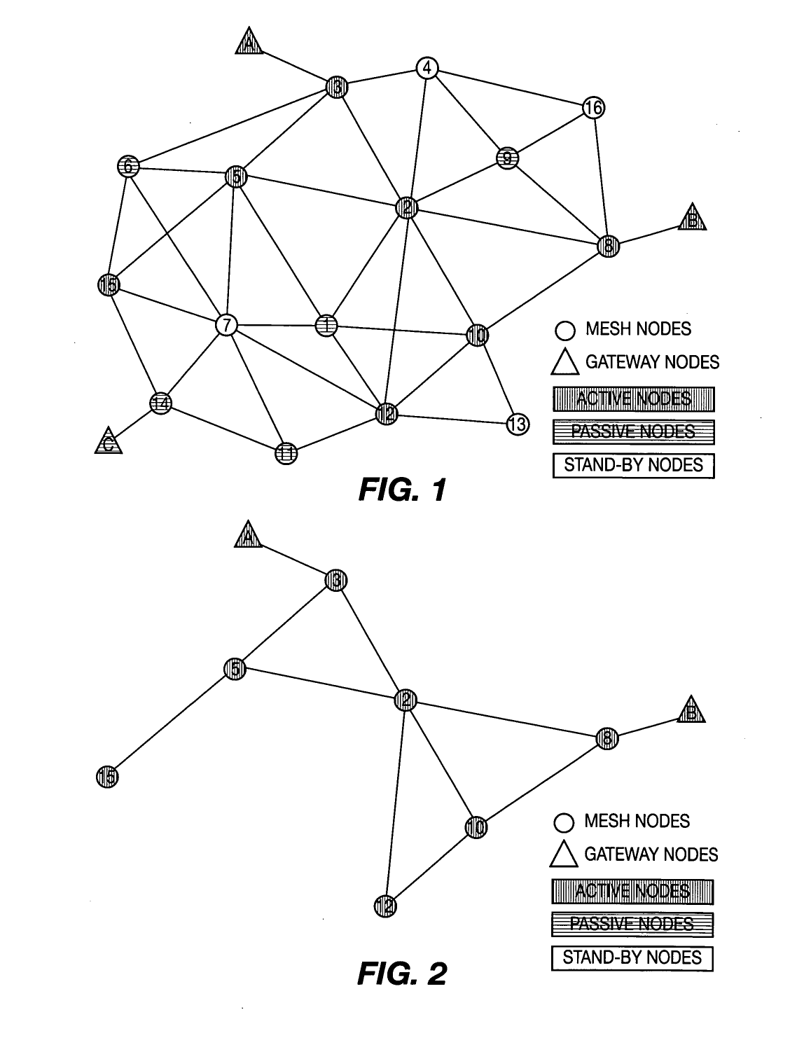

FIG. 1 shows an example of a network with 16 mesh nodes and three gateway nodes, where the network is divided into three different levels: a physical level, a first logical level (A or primary), and a second logical level (B or secondary). Hence, the same physical network can be seen as three different networks. FIG. 1 also shows all existing nodes and possible interconnections.

Network nodes can be classified as either mesh nodes or gateway nodes. Mesh nodes are common nodes (e.g., 802.11 MPs or MAPs) that can be interconnected in a mesh fashion. Gateway nodes are nodes that provide connectivity outside of the mesh domain. Nodes are marked as Active, Passive, or Stand-by according to their involvement in the network, for example.

There are many paths that can be taken if, for instance, traffic generated in Node 2 needed to be forwarded to a gateway. Potential paths include 2-3-A, 2-4-3-A, 2-8-B, 2-9-8-B, etc. However, if only the nodes marked as Active are considered, the number of possible paths is significantly reduced. In this example, the paths 2-4-3-A and 2-9-8-B are no longer valid.

FIG. 2 shows the same network as seen when considering only Active nodes. From the data traffic point of view, this change in network topology could be used for different purposes, such as separating traffic. By considering only Active nodes, traffic gets forwarded in more deterministic paths, which can help in keeping quality of service (QoS) requirements.

The criteria for deciding which nodes are Active could be based on better RRM characteristics such as more reliable links, battery level, traffic generation characteristics, security and authentication context of nodes, or level of resource utilization. The criteria used and their manner of evaluation are implementation-specific, and the particular implementation chosen to determine which nodes are Active does not alter the construction or operation of the present invention.

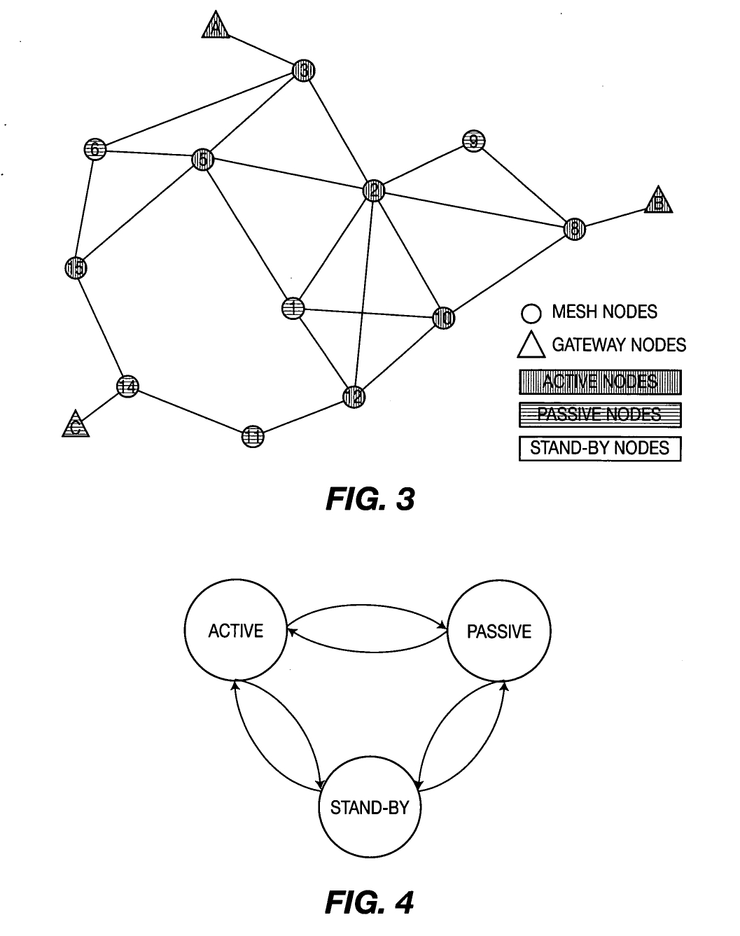

Another logical network could be defined if Passive nodes are considered in addition to Active nodes. This implies that the number of valid paths can be increased. Looking at FIG. 3, which shows the same network as seen when considering Active and Passive nodes, the path 2-9-8-B becomes valid again. Since the number of paths increases, the data forwarding becomes less deterministic. It is less desirable (from the QoS point of view) when the data forwarding becomes less deterministic; however, it could be beneficial for other reasons such as path redundancy. For example, high priority signaling could be forwarded through this secondary network using a shorter path, allowing for lower latency.

The main difference between Active and Passive nodes is that the amount and nature of traffic that passes through them is quite different. This makes a considerable difference when performing RRM functions. It is expected that Active nodes would require more resources than Passive and Stand-by nodes. The RRM functions could be applied taking only Active nodes into account. This would reduce the complexity of the RRM functions and make them more efficient, since Active nodes should be more carefully managed than the rest of the network.

Stand-by nodes are nodes that could be in a power-save mode. These nodes could be in the Stand-by mode for several possible reasons: the nodes are not generating traffic, the nodes are performing battery savings, or because of a combination of these and other reasons. Also, the nodes could be toggling between Passive and Stand-by modes.

Even though this example shows only three node states (i.e., Active, Passive, and Stand-by), additional node states could easily be envisioned by one skilled in the art.

A simple way to keep track of the different logical networks is by implementing a state machine at each node. Hence, different logical networks can be quickly defined by knowing the state of neighboring nodes.

FIG. 4 shows a state machine for the three proposed states. The current state of every node can be advertised by means of signaling exchanges (wireless or wired interfaces) between nodes in the mesh network. This signaling exchange can be implemented at various possible protocol layers and can be of either broadcast, multicast (point to multi-point), or dedicated (point to point) type. Alternatively, a predetermined set of rules can be implemented in each node, allowing the network to deduce the current state of the network instead of explicitly signaling the current state of the network from observing certain characteristics like traffic flow, quality, delay, etc.

There could be many levels for dividing the network into different classes and the classes are not required to be subgroups of other classes. For example, there could be different sets of nodes defined as Active but handling different classes of services for data traffic.

Splitting a network into multiple mesh sub-networks can be done at start-up or at any time during the operation of the network. Splitting the network can be performed as a result of a change in network conditions (e.g., traffic load), for performance optimization and/or reliability. When the traffic load decreases, the sub-networks could combine to form one large mesh network.

One way that the network could be separated into multiple sub-networks is to have a simple metric (e.g., number of hops, delay, etc.) that is used to determine if it makes sense to have one large mesh network or multiple smaller mesh networks. In general, there are two approaches for managing mesh networks: centralized or distributed. Network separation can be performed from a central controlling point in the network, or individually by each one of the nodes. A hybrid approach can also be used, in which a subset of nodes (e.g., Active nodes) are the ones that take the decision. In the hybrid approach, the nodes have the choice to inform secondary (or Passive) nodes of the new configuration, or the nodes can simply act as proxy nodes and hide the configuration from the secondary nodes. Again, the two mesh networks may or may not be interspersed into one another or just bordering. It is also possible to have a gateway node between the two mesh networks, in addition to the mesh to landline gateway that each mesh node would have.

Organizing certain nodes in the mesh network into logical sub-networks is a means to ease management of the mesh network as a whole. Any given node in the mesh network can simultaneously belong to one or more logical sub-networks in the mesh. Different logical sub-networks could be created to accomplish (but is not limited to) the following purposes:

(1) A set of nodes dedicated to mesh network maintenance (such as RRM, O&M, monitoring, etc.).

(2) A primary set of nodes that are dedicated to routing.

(3) A secondary set of nodes that are dedicated to routing as a fallback in case of problems.

(4) A set of nodes that are dedicated to routing specific traffic classes.

(5) A set of nodes at the edge of the overall mesh network that are dedicated to broadcasting and advertising the mesh.

(6) Separation of traffic from different service providers or with different QoS requirements sharing the same physical network.

Belonging to a certain physical or logical mesh sub-network is not permanent, although this may be practical for some purposes. Based on various decision criteria, any given node in the mesh can be released and re-attached to another physical or logical sub-network at any time during the normal course of operation. Possible triggers for a node's re-attachment may include changes in: RRM conditions, traffic conditions, or security or authentication context.

In order to manage physical and logical sub-networks in the mesh, one or more of following elements can be used:

(1) One or more state-machines/databases in a node to keep track of the node's current attachment. In a preferred embodiment, each node takes care of its own state machine and attachments, informing other nodes via signaling whenever the state is changed. In the centralized approach, only the central or master node needs to be informed of a change in state. In the distributed approach, a change in state is broadcast to the entire network. In the hybrid approach, the cluster master is informed of a change in state, which informs the attached nodes. While the hybrid approach is preferred, there are advantages associated with the centralized and distributed approaches, depending on the specific size of the network, deployment characteristics, etc. As long as each node takes care of its attachments, the routing mechanism can be performed in a source-base, hop-base, or central-base fashion (the latter being performed at a master node).

(2) Signaling mechanisms between nodes (wired and wireless interfaces, all possible protocol layers) to inform other nodes about requests from other nodes or force a state change of other nodes in the mesh.

(3) A set of rules implemented in the nodes to determine or deduce attachment.

The sub-networking concept can be applied to different scenarios. For instance, there could be a case where a physical mesh network changes topology due to the dynamic system environment, movement of the nodes, etc. This could cause the original mesh to completely disconnect at a certain point which may result in splitting the mesh in two different meshes. Provided that there is still communication between the two meshes (e.g., through the wired or some other type of Distribution System, backhaul, core network, etc.), the two separate meshes can still be considered a single logical mesh (or a multiple of them) which allows all original network configurations to remain in place. Hence, two or more physical mesh networks could be considered as a single or multiple logical mesh(es), regardless of dynamic topology changes. This concept can also be implemented to keep the set of rules applied to different network nodes independent of the physical network topology by considering the logical configuration and/or connections instead of the physical ones.

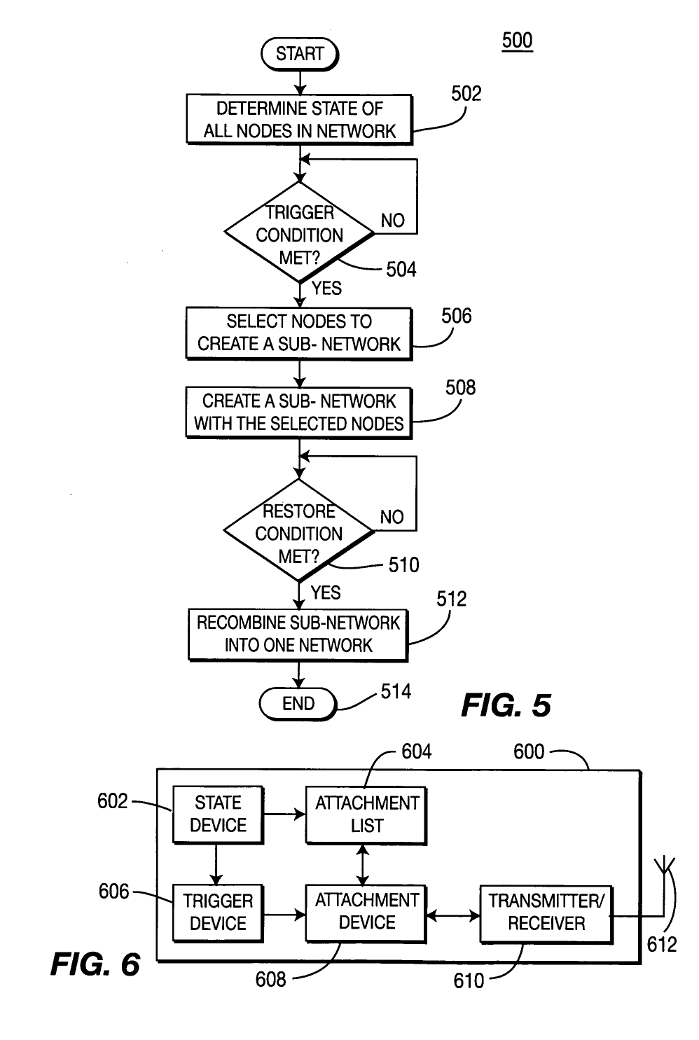

FIG. 5 is a flowchart of a method 500 for separating a mesh network into multiple sub-networks. The method 500 begins by determining the state of all the nodes in the network (step 502). A determination is made whether a trigger condition is met to separate the network into sub-networks (step 504). If the trigger condition is not met, the network continues operating as a single network until the trigger condition is met. If the trigger condition is met, nodes are selected to create a sub-network (step 506). It is noted that multiple criteria can be used to select the nodes that will be part of the sub-network, as described above.

The multiple sub-networks are created (step 508) and will continue to operate as sub-networks until a restore condition is met (step 510). If the restore condition is met, the multiple sub-networks will be recombined into one network (step 512) and the method terminates (step 514). As described above, multiple criteria can be used to determine when to recombine the sub-networks.

The methods described above can be used in connection with any type of mesh network, including but not limited to, 802.11 WLAN (such as 802.11s), 802.15 wireless personal area network (WPAN, such as 802.15.5), and 802.21 networks.

FIG. 6 is a block diagram of a node 600 configured to implement the method 500. The node 600 includes a state device 602, an attachment list 604, a trigger device 606, an attachment device 608, a transmitter/receiver 610, and an antenna 612. The state device 602 maintains the current state of the node 600 (e.g., Active, Passive, or Stand-by) and communicates the state of the node 600 to the attachment list 604 and the trigger device 606. The attachment list 604 contains a list of all of the other nodes that the node 600 is currently attached to and the current state of those nodes. The trigger device 606 is used to determine when the node 600 should leave the network that it is currently attached to; this determination can be based, in part, on the current state of the node 600. It is noted that the trigger device 606 may not be operable in all network configurations, particularly in a network where the decision to form sub-networks is made by a central entity.

The attachment device 608 communicates changes in state of the node 600 and whether the node 600 is going to change networks to all of the nodes in the attachment list 604. The transmitter/receiver 610 send the changes from the attachment device 608 via the antenna 612. The transmitter/receiver 610 also receives information regarding the state of nodes in the attachment list 604 which is constantly updated.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for creating sub-networks in a wireless mesh network, comprising the steps of:
determining whether a trigger condition for creating a sub-network exists;
selecting nodes in the mesh network to create the sub-network if the trigger condition exists; and
creating the sub-network with the selected nodes.

2. The method according to claim 1, wherein the trigger condition includes a change in conditions in the mesh network.

3. The method according to claim 1, wherein the trigger condition is generated by a central control point in the mesh network.

4. The method according to claim 1, wherein the trigger condition is generated individually by each node in the mesh network.

5. The method according to claim 1, wherein the trigger condition is generated by a subset of nodes in the mesh network.

6. The method according to claim 1, further comprising the step of:
determining a state of all nodes in the mesh network.

7. The method according to claim 6, wherein each node maintains a record of its current state.

8. The method according to claim 6, wherein each node signals its current state to other nodes in the mesh network.

9. The method according to claim 6, wherein the selecting step includes selecting nodes based upon the state of the node.

10. The method according to claim 1, further comprising the steps of:
determining whether a restore condition exists; and
combining sub-networks into a single mesh network if the restore condition exists.

11. The method according to claim 10, wherein the restore condition includes the mesh network returning to a condition prior to the trigger condition existing.

12. The method according to claim 1, wherein a node can belong to more than one sub-network.

13. The method according to claim 1, wherein the node can change sub-networks at any time.

14. A node for use in a wireless mesh network, comprising:
a state device, said state device maintaining a state of the node, the state of the node relating to activity occurring at the node;
an attachment list communicating with said state device;
a trigger device communicating with said state device; and
an attachment device communicating with said attachment list and said trigger device.

15. The node according to claim 14, wherein said attachment list includes all other nodes that the node is attached to.

16. The node according to claim 14, wherein said trigger device determines when to form a sub-network.

17. The node according to claim 14, wherein said attachment device notifies other nodes in the mesh network of a change in the state of the node; and
receives the states of other nodes in the mesh network and records the states of the other nodes in said attachment list.

18. The node according to claim 17, wherein the node can belong to more than one sub-network.

19. The node according to claim 17, wherein the node can change sub-networks at any time.
